(19) United States
(12) Patent Application Publication
(10) Pub. No.: US 2026/0324562 A1
(43) Pub. Date: Oct. 22, 2026

(54) DELIVERY OF CONDITIONED GREENHOUSE AIR VIA A VARIABLE OPEN FRACTION DIFFUSER

(71) Applicant: SENSEI AG HOLDINGS. INC., Santa Monica, CA (US)

(72) Inventors: William Daniel Hillis, Santa Monica, CA (US); Jascha Tucker Little, Seattle, WA (US); Dimitar boykov Vassilev, Los Angeles, CA (US)

(21) Appl. No.: 19/184,748

(22) Filed: Apr. 21, 2025

(51) Int. Cl. A01G 9/24; F24F 13/12

(52) U.S. Cl. CPC A01G 9/246; F24F 13/12

(57) ABSTRACT

The open fraction of a diffuser is varied in a controllable fashion along the length of an under-table plenum to control the velocity of conditioned air delivered to a plant canopy. Locally increasing the open-fraction of the diffuser along a portion of the plenum enables power-efficient, on-demand delivery of conditioned air at relatively high average velocity at prescribed locations while still allowing, at other times, uniform delivery of conditioned air at relatively low average velocity along the entire length of the plenum.

### TECHNICAL FIELD

Various of the disclosed embodiments concern greenhouse climate control.

### BACKGROUND

Greenhouses must provide a nurturing environment for the plants that are grown within them. For example, a greenhouse must maintain an appropriate temperature and humidity within the plant canopy if the plants in the greenhouse are to thrive. However, given the wide range of external temperatures and often extreme solar loadings (e.g. the “greenhouse effect”) experienced by a greenhouse, maintaining optimal or even acceptable growing conditions within the canopy can be difficult.

Many current greenhouse designs include a heating and cooling scheme that blows heated (or cooled) air from one end of greenhouse and allows the air to heat (or cool) the plant canopy and greenhouse interior until it exits another end of the greenhouse. This configuration can lead to non-uniformity in the temperature along the length of the greenhouse as the conditioned air is exposed to the heat transfer action of the plant canopy as it flows along the length of the plant canopy. Specifically, when warm (or cool) air is introduced into the greenhouse those plants nearest the conditioned air source receive warmer (or cooler) air, while those plants further away from the conditioned air source receive air that is not as warm (or cool) as the air was when it was first introduced into the greenhouse. As a result, the plants may not be uniformly warmed (or cooled).

An alternative strategy, discussed in the referenced application, is to deliver conditioned air through a plenum beneath the table supporting the plant canopy, with the conditioned air emerging upward into the plant canopy through a diffuser generally coincident with the upper surface of the table. Given that the conditioned air will experience comparatively little heat transfer when flowing through the empty under-table plenum (especially if the plenum is insulated), this strategy has the potential to deliver conditioned air of uniform temperature to the plant canopy along the length of the greenhouse. However, delivering a uniform velocity of conditioned air along the length of the greenhouse presents a new challenge.

A rule of thumb governing the uniformity of the average velocity of the conditioned air delivered along the length of the plenum is that the total open area of the diffuser openings should be comparable to or less than the cross-sectional area of the plenum. For example, one study1 specifically suggests that this aperture ratio be kept below 1.5. Consequently, maintaining plenums of reasonable height (with acceptably low associated construction and excavation costs), while still permitting tables of acceptable length, favors diffusers with a relatively low open fraction, where the open fraction of the diffuser is the total open area of the diffuser openings to the total area of the diffuser. For example, for a plenum length of 60 m and a plenum height of 1.5 m, an open fraction of 0.0375 is required to provide an aperture ratio of 1.5. This open fraction may be achieved, for example, with a diffuser with circular holes 2 mm in diameter on a square grid with 9.15 mm pitch.

It may also be desirable, at least some of the time, to deliver conditioned air upward through the diffuser at a relatively high average velocity. For example, under certain psychrometric conditions, average conditioned air velocities as high as 0.4 m/s may be recommended to prevent tip burn in some crops.

The concurrent demands for a low diffuser open fraction and potentially high velocities emerging from the diffuser present a challenge to efficient greenhouse operation. The pressure drop of the air flow across the diffuser scales with the square of the average conditioned air velocity and inversely with the square of the open fraction of the diffuser. The power required to move the conditioned air through the diffuser (which scales with the product of the pressure drop and average air velocity) therefore scales with the cube of the average air velocity and inversely with the square of the open fraction. Delivering high ¹ Colin M. Wells and Nevin D. Amos. Design of air distribution system for closed greenhouses. Acta Hortic, 361:93-104, 1994. velocities uniformly outward from the diffuser along the entire length of the plenum can therefore require substantial power.

For example, assuming a discharge coefficient of 0.61 for the diffuser holes, delivering conditioned air at an average velocity of 0.4 m/s through the plenum and diffuser described above would require approximately 54 kW of power. Such power requirements are substantial enough that the power required to operate the fans circulating the air through the plenum may present a significant fraction of the overall greenhouse power consumption.

It would be advantageous to enable relatively low-power delivery of relatively high average velocity conditioned air to a plant canopy via a diffuser atop an under-table plenum. More specifically, it would be advantageous to provide on-demand delivery of conditioned air at relatively high average velocity at prescribed locations while still allowing, at other times, uniform delivery of conditioned air at relatively low average velocity along the entire length of the plenum.

### SUMMARY

The invention varies, in a controllable fashion, the open fraction of a diffuser along the length of an under-table plenum to control the velocity of conditioned air delivered to a plant canopy. In particular, locally increasing the open-fraction of the diffuser along a portion of the plenum enables power-efficient, on-demand delivery of conditioned air at relatively high average velocity at prescribed locations while still allowing, at other times, uniform delivery of conditioned air at relatively low average velocity along the entire length of the plenum.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 shows a schematic of a greenhouse with the uniform delivery of conditioned air via a sub-table plenum according to an embodiment of the invention.

FIG. 2 shows a schematic of a greenhouse with the localized delivery of conditioned air at relatively high average velocity at a prescribed location according to an embodiment of the invention.

FIGS. 3A-3E show a diffuser construction with variable open fraction according to an embodiment of the invention.

FIGS. 4A and 4B show an alternative diffuser construction with variable open fraction according to an embodiment of the invention.

FIGS. 5A and 5B show an exemplary presser plate actuator for controlling the open fraction of a diffuser segment according to an embodiment of the invention.

FIG. 6 shows a chain and cam mechanism for engaging the presser plate actuator of FIGS. 5A and 5B according to an embodiment of the invention.

FIGS. 7A and 7B show a schematic representation of an exemplary push-rod actuator for controlling the open fraction of a diffuser segment according to an embodiment of the invention.

FIG. 8 shows a series of diffuser segments with variable open fraction controlled by the push-rod actuator of FIGS. 7A and 7B according to an embodiment of the invention.

FIG. 9 shows a detailed design of the push-rod actuator of FIGS. 7A and 7B according to an embodiment of the invention.

FIG. 10 shows a detailed design of the attachment mechanism of the push-rod actuator of FIGS. 7A and 7B according to an embodiment of the invention.

### DETAILED DESCRIPTION

The invention enables relatively low-power delivery of relatively average high velocity conditioned air to a plant canopy via a diffuser atop an under-table plenum. The invention overcomes the above-described tradeoff between power consumption and velocity uniformity by varying, in a controllable fashion, the diffuser open fraction along the length of the plenum. Locally increasing the open-fraction of the diffuser along a portion of the plenum enables on-demand delivery of conditioned air at relatively high average velocity at prescribed locations while still allowing, at other times, uniform delivery of conditioned air at relatively low average velocity along the entire length of the plenum.

### Overview of Operation

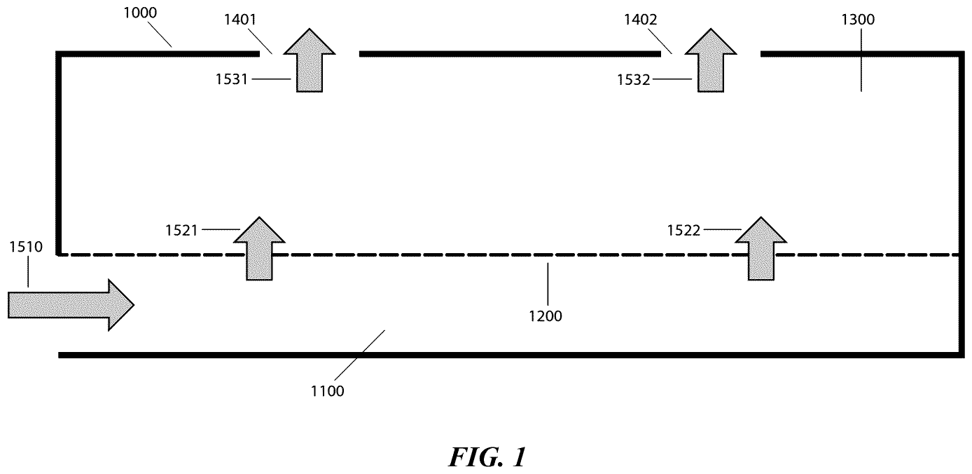

FIG. 1 shows a schematic of a greenhouse with the uniform delivery of conditioned air via a sub-table plenum according to an embodiment of the invention. The conditioned air enters 1510 the greenhouse 1000 at one end of the plenum 1100 and flows along the length of the plenum. The conditioned air emerges 1521, 1522 from the plenum through openings in a diffuser 1200 that is substantially coincident with the upper surface of the plenum and beneath the table supporting the plant canopy. For clarity, neither the table nor the plant canopy are shown. Upon emerging from the diffuser, the conditioned air flows through the plant canopy and into the primary chamber 1300 of the greenhouse, before flowing 1531, 1532 out of the greenhouse through one or more vents 1401, 1402 exhausting from the primary chamber to the greenhouse exterior. The open fraction of the diffuser is uniform along the length of plenum and such that the aperture ratio remains low enough to deliver uniform flow along the length of the plenum. That is, the average conditioned air velocity 1521 is substantially the same as the average conditioned air velocity 1522.

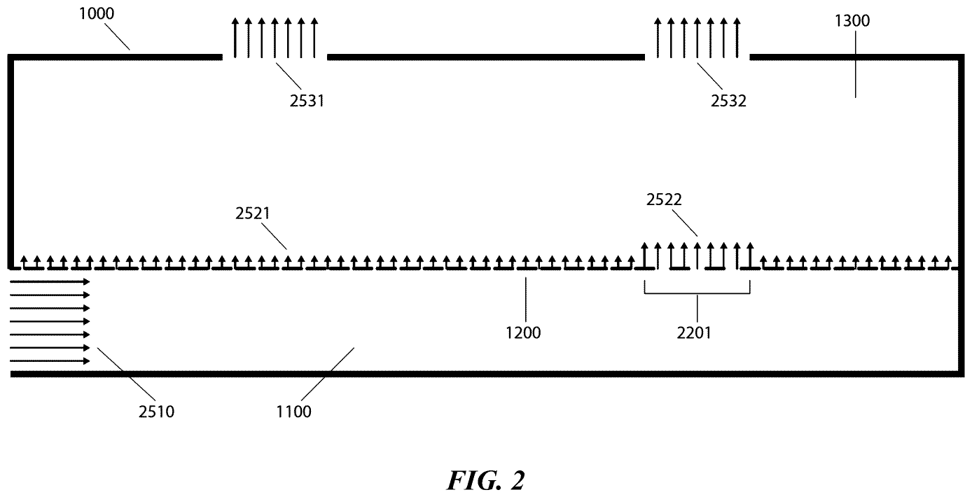

FIG. 2 shows a schematic of a greenhouse with the localized delivery of conditioned air at relatively high average velocity at a prescribed location according to an embodiment of the invention. As in FIG. 1, the conditioned air enters 2510 the greenhouse at one end of the plenum 1100 and flows along the length of the plenum. Also as in FIG. 1, the air exhausts 2531, 2532 from the primary chamber 1300 of the greenhouse through one or more vents. However, in FIG. 2, a segment 2201 of the diffuser 1200 has an open fraction that is greater than the remainder of the diffuser. Consequently, the average velocity of the conditioned air emerging 2522 from the diffuser along the segment is greater than the average velocity of the conditioned air emerging 2521 from the remainder of the diffuser. The location of the segment 2201 along the length of the plenum can be varied over time so that the relatively high average velocity conditioned air can be delivered to all portions of the plant canopy.

### Open Fraction Variation

As illustrated in FIG. 2, operation of the invention relies upon controlled variation of the diffuser open fraction along the length of the plenum. The invention may use one or more of several approaches to varying the open fraction. In one approach, the open fraction is varied between two discrete values (e.g. normal and high). In another approach, the open fraction is varied between three discrete values (e.g. zero, normal, and high). In yet another approach, the open fraction may be varied continuously between a minimum (e.g. zero) and a maximum open fraction.

One skilled in the art will appreciate that these approaches may be implemented by a variety of diffuser constructions and actuated by a variety of actuators. Different combinations of diffuser constructions and actuators may also be selected to yield particular spatial and temporal patterns of the open fraction variation. Examples of diffuser constructions and actuators are described in greater detail below.

### Exemplary Diffuser Construction

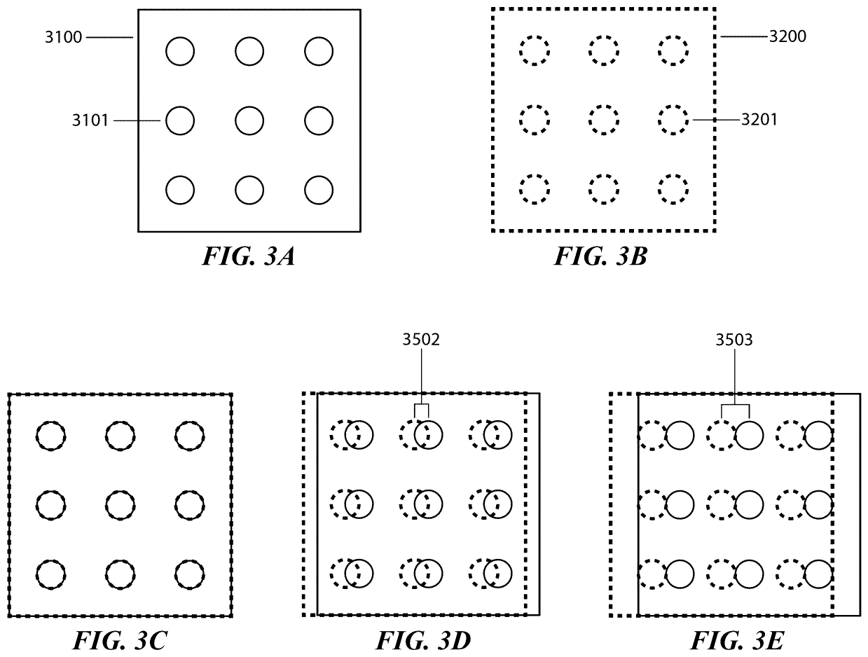

FIGS. 3A-3E show a diffuser construction with variable open fraction according to an embodiment of the invention. The diffuser is constructed from two substantially identical, stacked diffuser plates that may slide, in-plane, relative to one another, along one dimension. Each diffuser plate has a number of openings arrayed in a periodic fashion along the sliding dimension. Preferably, the openings are of constant size and shape and are also arrayed in a periodic fashion along a second dimension different from the sliding dimension (e.g. perpendicular to the sliding dimension). For example, in FIGS. 3A-3E, circular holes are arrayed on a square grid. For simplicity, each of the diffuser plates 3100, 3200, of FIGS. 3A-3E are shown with a small number of openings 3101, 3201. In most embodiments of the invention the diffuser plate will have many more (e.g. thousands of) openings.

The open fraction of the diffuser is determined by the offset of the stacked diffuser plates, along the sliding dimension, away from perfect alignment of the openings. In FIG. 3A, the openings are in alignment, and the open fraction of the diffuser matches the open fraction of each of the individual diffuser plates. In FIG. 3B, one diffuser plate has been shifted by an offset 3502, thereby reducing the open fraction of the diffuser. In FIG. 3C, one diffuser plate has been shifted by an offset 3503 equal to (or greater than) the characteristic length of the openings along the sliding dimension (i.e. the diameter of the circular openings), reducing the open fraction to zero.

The diffuser construction of FIGS. 3A-3E can be used to implement any of the approaches of varying the open fraction described above. Specifically, variation between two discrete values may be implemented by discrete shifts between two configurations similar to those shown in FIGS. 3A-3E (e.g. FIG. 3A and FIG. 3C). Variation between three discrete values may be implemented by discrete shifts between three such configurations. Finally, continuous variation of the open fraction may be implemented by continuous movement between any two configurations similar to those shown in FIGS. 3A-3E, with the chosen configurations determining the minimum and maximum open fractions.

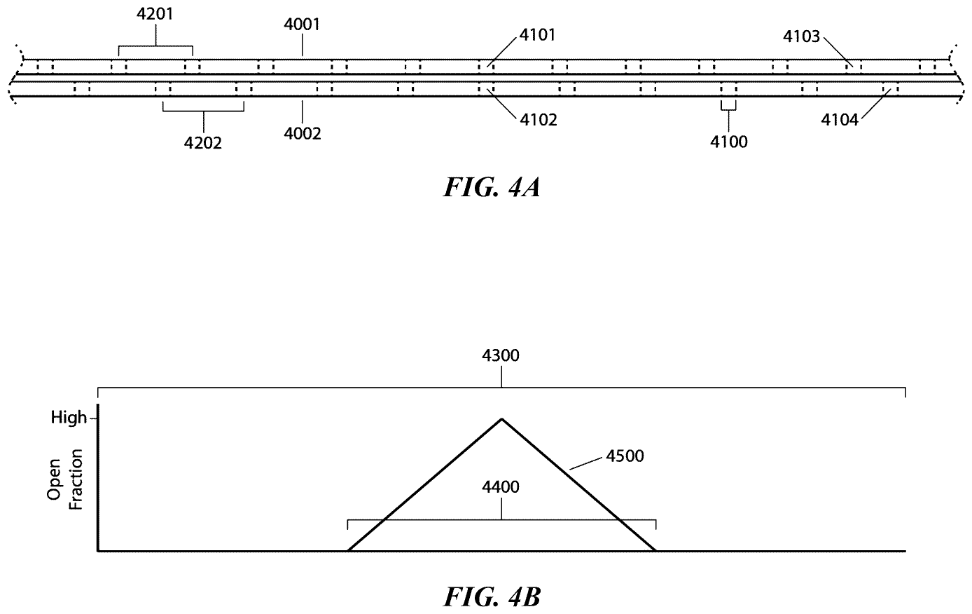

FIGS. 4A and 4B show an alternative diffuser construction with variable open fraction according to an embodiment of the invention. As in FIGS. 3A-3E, the diffuser is constructed from two stacked diffuser plates that may slide, in-plane, relative to one another, along one dimension. Each diffuser plate has a number of openings arrayed in a periodic fashion along the sliding dimension. However, in contrast to FIGS. 3A-3E, the plates are not substantially identical. Rather, the period of the openings (i.e. the spacing between the openings) differs between the upper diffuser plate and lower diffuser plate. The interference between these differing periods creates a beat period over which the open fraction varies between a high value and zero.

FIG. 4A shows an edge-on view of an upper diffuser plate 4001 and a lower diffuser plate 4002 in such a diffuser construction. Approximately one beat period of the diffuser plates is shown in FIG. 4A. The diffuser plates may extend for more than one beat period. As described above, the period 4201 of the openings in the upper diffuser plate differs from the period 4202 of the openings in the lower diffuser plate. The alignment of the openings in the upper diffuser plate and lower diffuser plate thus varies over the beat period. At the location of openings 4101 and 4102, the openings are in alignment, yielding a locally high open fraction. At the location of openings 4103 and 4104, the openings are out of alignment, yielding an open fraction of zero.

FIG. 4B shows the open fraction profile over one beat period 4300 for the diffuser construction of FIG. 4A. Preferably, as shown in FIG. 4A, the characteristic length of the openings along the sliding dimension is the same for the upper diffuser plate and lower diffuser plate. In this case, the beat period is equal to the product of the upper and lower opening periods divided by the difference between the upper and lower opening periods. In the case of square openings, the open fraction 4500 varies linearly between zero and the high value. Provided the characteristic length of the opening along the sliding dimension is not greater than half the lesser of the upper and lower opening periods, the open fraction attains a non-zero value over only a portion 4400 of the beat period. If the characteristic length of the openings along the sliding dimension is the same for the upper diffuser plate and lower diffuser plate, the width of this portion is the product of twice the characteristic length and the greater of the upper and lower opening periods divided by the difference between the upper and lower opening periods.

The position of the open fraction profile within the beat period can be controlled by sliding the upper diffuser plate and lower diffuser plate relative to one another. Preferably, the diffuser construction and actuator can produce a sliding distance of at least half the lesser of the upper and lower opening periods. A slide of this distance shifts the open fraction profile by half the beat period, providing full control of the open fraction profile within the beat period. One skilled in the art will appreciate that appropriate selection of the opening width and opening periods, appropriately paired with the various actuators and control schemes described below, can produce a great variety of open fraction profiles along the length of the plenum.

### Segmented Control of Diffuser Open Fraction

To better enable control of the open fraction along the length of the plenum, the diffuser may be segmented along the length of the plenum and the open fraction controlled for each diffuser segment. The length of the diffuser segments (along the length of the plenum) is preferably uniform, but may alternatively vary from one segment to another along the length of the plenum. The length of the diffuser segments may be chosen to balance improved spatial resolution of the open fraction control with increasing complexity of the control system. For example, for the 60 m plenum described above, a segment length of 2 m will provide 30 segments, sufficient for many growing applications. In some embodiments of the invention, the diffuser may also be segmented along the width of the greenhouse. In such embodiments, the open fraction may also be controlled along the width of the plenum. Preferably, each segment of the diffuser is constructed of two stacked diffuser plates as shown in FIGS. 3A-3E or FIGS. 4A and 4B.

One or more of a wide variety of control schemes may be implemented for controlling the open fraction along the length of the plenum, depending on the specific actuators used to shift one of the stacked diffuser plates relative to the other. For actuators capable of addressing diffuser segments individually, essentially any piecewise spatial and temporal function may be specified over the diffuser segments along the length of the plenum. For example, the open fraction may be controlled to provide a piecewise approximation of a sinusoidal function along the length of the plenum, with the sinusoidal function propagated along the length of the plenum over time.

However, for some actuators (including an actuator described in greater detail below), it may be expedient for the control scheme to address the diffuser segments in banks, with each bank including one or more diffuser segments. Preferably, at a given moment in time, one bank of diffuser segments has a relatively high open fraction while others have a relatively low open fraction, providing the localized delivery of relatively high velocity conditioned air as described above. Each bank may be a contiguous group of diffuser segments along the length of the plenum or may be interleaved along the length of the plenum. In many embodiments of the invention, the control scheme further results in the position of the high-open-fraction bank propagating along the length of the plenum over time, ensuring that, over time, the relatively high average velocity conditioned air is delivered in turn to all portions of the plant canopy.

Control of the open fraction may be programmatic (i.e. open-loop), in accordance with a prescribed growing plan, or adaptive (i.e. closed-loop), in response to specific environmental conditions (e.g. temperature, humidity, or velocity of air flow) sensed within the plant canopy.

### Exemplary Actuators

### Presser Plate Actuator

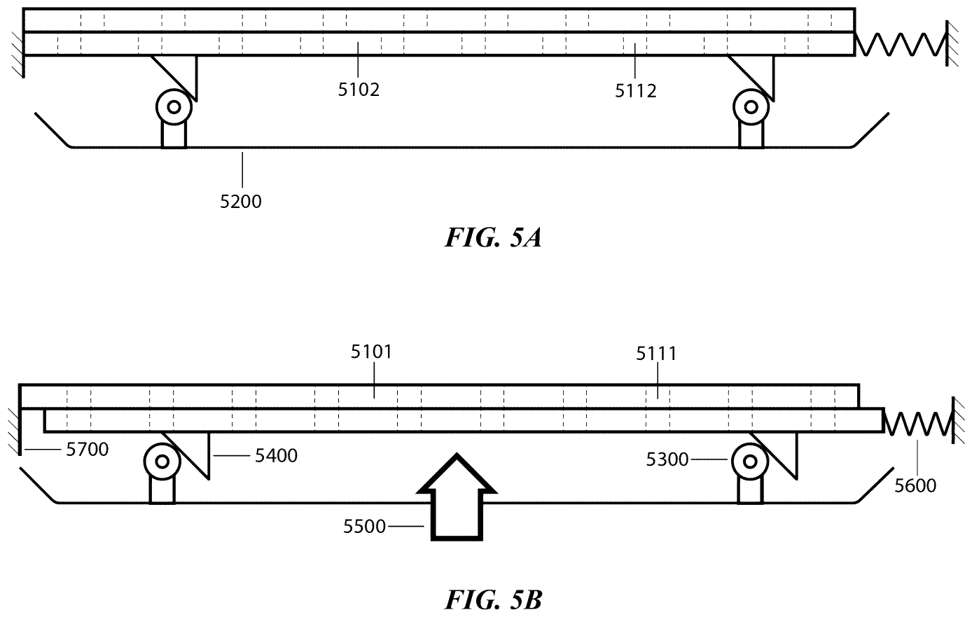

FIGS. 5A and 5B show an exemplary presser plate actuator for controlling the open fraction of a diffuser segment according to an embodiment of the invention. As described in FIGS. 3A-3E, the diffuser segment comprises two stacked diffuser plates with periodic openings. In FIG. 5A, the openings 5111 and 5112 of the upper diffuser plate 5101 and lower diffuser plate 5102 are fully offset (by the characteristic length of the openings) yielding an open fraction of zero. The lower diffuser plate is coupled to one or more ramps 5400 that are in mechanical contact with one or more rollers 5300 coupled to a presser plate 5200. The shape of the ramps is such that an upward movement of the presser plate induces a lateral shift of the lower diffuser plate. In FIG. 5B, an upward movement 5500 of the presser plate has shifted the lower diffuser plate rightward, eliminating the offset of the openings. The openings are in alignment, yielding a maximum open fraction in which the open fraction of the diffuser matches the open fraction of each of the individual diffuser plates. A spring 5600 ensures that when the force inducing the upward movement of the presser plate is released, the lower diffuser plate will return to the position of FIG. 5A, against a stop 5700 opposing the force of the spring.

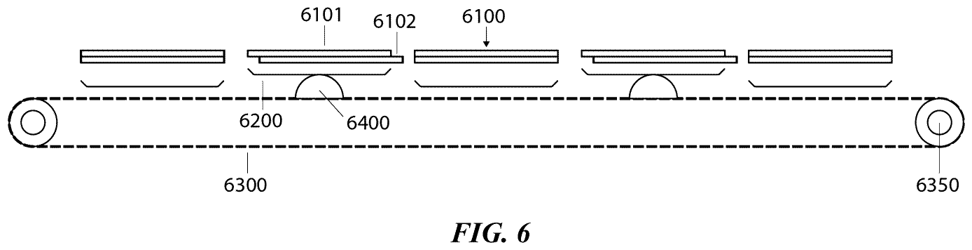

FIG. 6 shows a chain and cam mechanism for engaging the presser plate actuator of FIGS. 5A and 5B according to an embodiment of the invention. A chain 6300 tensioned between two pulleys 6350 travels within the plenum, beneath and substantially parallel to each of several diffuser segments 6100. For clarity, the table structure that provides a seal between adjacent diffuser segments is not shown in FIG. 6. Also for clarity, only the presser plate 6200 and diffuser plates associated with each of the several diffuser segments are shown; the remainder of the mechanisms in FIGS. 5A and 5B are omitted from FIG. 6. One or more cams coupled with the chain engage and induce and upward movement in the presser plates as they pass beneath the presser plates. In FIG. 6, a cam 6400 has engaged a presser plate 6200, inducing a later shift in a lower diffuser plate 6102 relative to an upper diffuser plate 6101. The chain may run in a track (not shown) providing structural support for the cam as it presses upward against the sprung and frictional forces of the presser plate and upper and lower diffuser plates.

As described in FIGS. 5A and 5B, the resulting offset of the lower diffuser plate results in a change in the open fraction of the diffuser segment. Preferably, and as shown in FIGS. 5A and 5B, the offset results in an increase in the open fraction. One skilled in the art will appreciate that the characteristic length of the diffuser openings, the resting alignment of the diffuser openings in the upper and lower diffuser plates, the height of the cam 6400 above the resting plane of the presser plates, and the slope of the ramp 5400 may be designed to enable any of the approaches to varying the open fraction described for FIGS. 3A-3E. For simplicity, the same approach is preferably implemented for all diffuser segments, though some embodiments of the invention may incorporate variation in the resting plane of the presser plate and slope of the ramps to provide segment-to-segment variation in the diffuser plate offset induced by the cam.

One skilled in the art will also appreciate that the length and shape of the presser plate, the length and shape of the cam along the chain, and the number and location of cams along the chain may be designed to enable many of the open fraction control schemes described above. For example, the number and position of the cams in FIG. 6, when applied to the upper and lower diffuser plates of FIGS. 5A and 5B, results in an interleaved bank of two high-open-fraction diffuser segments propagating along the length of the plenum as the chain moves the cams beneath the diffuser segments.

### Push-Rod Actuator

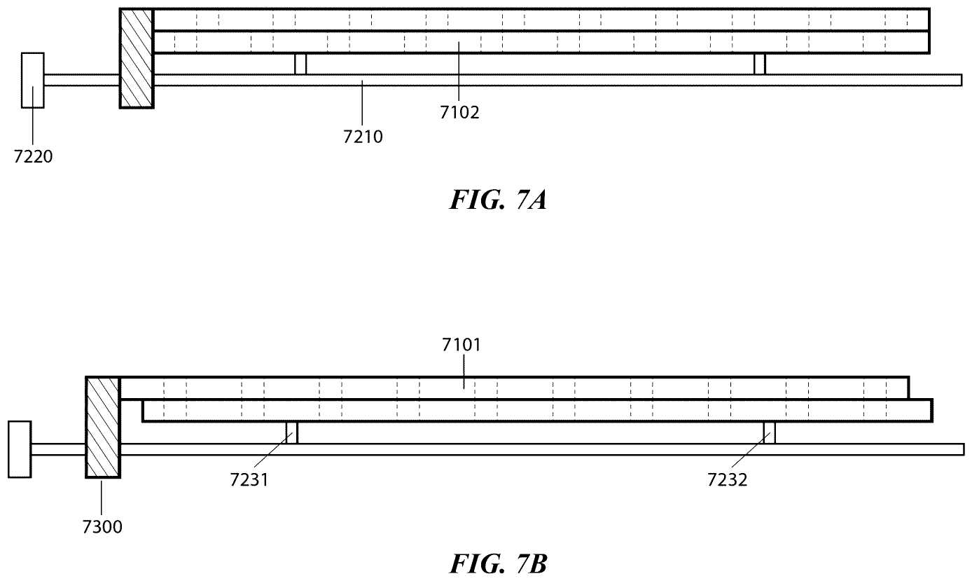

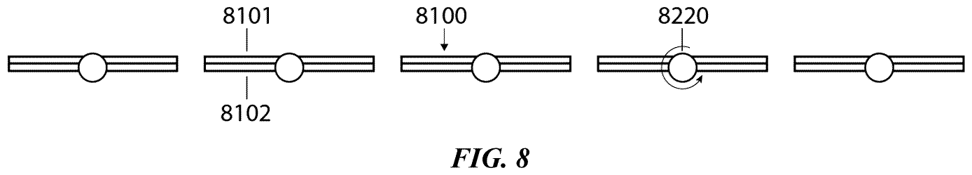

FIGS. 7A and 7B show a schematic representation of an exemplary push-rod actuator for controlling the open fraction of a diffuser segment according to an embodiment of the invention. A push-rod 7210 is coupled to the lower diffuser plate 7102 via attachment mechanisms 7231 and 7232. The push-rod passes through a nut 7300 that is fixed relative to the upper diffuser plate 7101. The nut and the portion of the push-rod that passes through the nut are threaded such that rotation of the push-rod via a drive wheel 7220 results in the advance or retraction of the push-rod relative to the nut and a corresponding shift of the lower plate relative to the upper plate. In FIG. 7A, the openings of the upper diffuser plate and lower diffuser plate are fully offset (by the characteristic length of the openings) yielding an open fraction of zero. In FIG. 7B, an advance of the push-rod has shifted the lower diffuser plate rightward, eliminating the offset of the openings. The openings are in alignment, yielding a maximum open fraction in which the open fraction of the diffuser matches the open fraction of each of the individual diffuser plates.
FIG. 8 shows a series of diffuser segments with variable open fraction controlled by the push-road actuator of FIGS. 7A and 7B according to an embodiment of the invention. Each diffuser segment 8100 has an upper diffuser plate 8101 and a lower diffuser plate 8102 attached to a push-rod. The open fraction of each diffuser segment is controlled by a drive wheel 8220. Specifically, rotation of a drive wheel results in an axial movement of the push-rod and a shift of the lower diffuser plate of the corresponding diffuser segment as described in FIGS. 7A and 7B. Note that in contrast to FIG. 6, the shift of the lower diffuser plate is along the width of the diffuser segment and across the width of the greenhouse.

One skilled in the art will appreciate that the push-rod actuator of FIGS. 7A and 7B and FIG. 8 allows for independent and continuous variation of the open fraction of each diffuser segment. For each diffuser segment, any open fraction between the minimum and maximum open fractions may be attained. The drive wheels of each diffuser segment may be operated manually or by a motorized drive mechanism. One skilled in the art will also appreciate that this actuator enables the manual or automated implementation of any of the open fraction control schemes described above. Specifically, because this actuator addresses diffuser segments individually, both the piecewise and banked control schemes may be implemented.

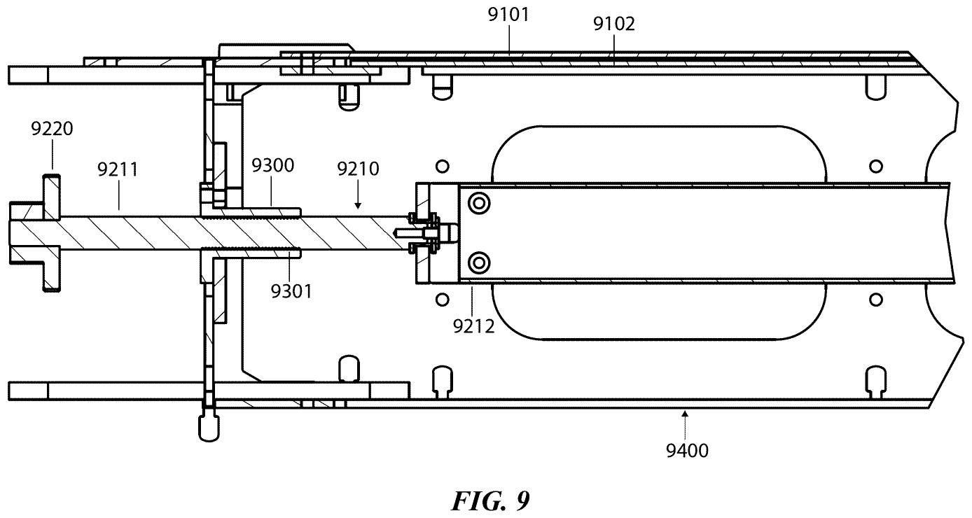

FIG. 9 shows a detailed design of the push-rod actuator of FIGS. 7A and 7B according to an embodiment of the invention. The push-rod 9210 comprises two components—a lead screw 9211 and box-section strut 9212. The lead screw is coupled to box-section strut and the drive wheel 9220. The lead screw passes through the nut 9300, engaging the nut at threads 9301. The push-rod is supported by a table structure 9400. The table structure also supports the upper diffuser plate 9101 and lower diffuser plate 9102.

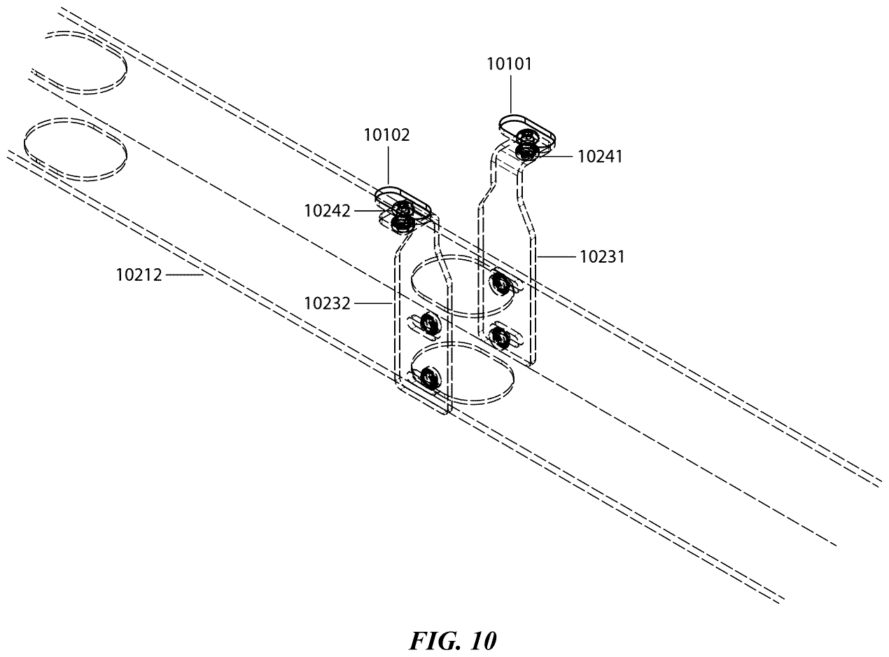

FIG. 10 shows a detailed design of the attachment mechanism of the push-rod actuator of FIGS. 7A and 7B according to an embodiment of the invention. The box-section strut 10212 of the push-rod is coupled with the attachment mechanism, namely brackets 10231 and 10232. The brackets attach to the lower diffuser plate (not shown) with fasteners 10241 and 10242. Access to the fasteners is provided by openings 10101 and 10102 in the upper diffuser plate (not otherwise shown).

### Alternative Applications

While the invention is primarily described herein as addressing the above-described power and uniformity tradeoff with the localized delivery of conditioned air at relatively high average velocity at prescribed locations, the invention may also be useful in applications where controlled, non-uniform delivery of condition air to the plant canopy is desired. For example, the open fraction may be varied to deliver different average velocities of conditioned air to different crops growing at different locations along the length or width of a greenhouse. Also for example, the open fraction may be varied to reduce or suppress entirely the delivery of conditioned air at specific locations at specific times to facilitate the planting, treatment, or harvesting of plants or more general greenhouse maintenance without disruption of the delivery of conditioned air at other locations.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. An apparatus for delivering conditioned air to a plant canopy comprising:
a plenum beneath one or more tables supporting said plant canopy, said conditioned air flowing through said plenum along the length of said plenum,
a diffuser substantially coincident with the upper surface of said plenum, said diffuser characterized by an open fraction, and
one or more actuators for varying said open fraction of said diffuser along said length of said plenum,
wherein said actuators vary said open fraction of a portion of said diffuser to vary the average velocity of conditioned air delivered to the portion of said plant canopy above said portion of said diffuser.

2. The apparatus of claim 1, wherein said actuators can vary said open fraction of said portion of said diffuser among a set of discrete values.

3. The apparatus of claim 1, wherein said actuators can vary said open fraction of said portion of said diffuser continuously between a minimum open fraction and a maximum open fraction.

4. The apparatus of claim 1,
wherein said diffuser comprises two stacked diffuser plates,
wherein each of said diffuser plates comprises a plurality of openings arrayed in a periodic fashion along a sliding dimension, and
wherein said actuators slide one of said diffuser plates relative to the other of said diffuser plates along said sliding dimension.

5. The apparatus of claim 1,
wherein said diffuser is segmented into a plurality of diffuser segments along said length of said plenum,
wherein said open fraction is substantially constant along the length of each of said diffuser segments, and
wherein said actuators control said open fraction of each of said diffuser segments.

6. The apparatus of claim 5,
wherein said actuators control said open fraction of each of said diffuser segments by addressing said diffuser segments in one or more banks, each of said banks comprising one or more diffuser segments,
and wherein said open fraction is substantially equal across said one or more diffuser segments.

7. The apparatus of claim 6, wherein said actuators vary, over time, the position of said banks of diffuser segments along said length of said plenum.

8. The apparatus of claim 4, each of said actuators comprising a presser plate, wherein an upward movement of said presser plate induces a shift of a lower of said stacked diffuser plates relative to an upper of said stacked diffuser plates along said sliding.

9. The apparatus of claim 8, additionally comprising
a chain beneath said diffuser moving along said length of said plenum,
one or more cams coupled to and arrayed along said chain,
wherein said cams engage said presser plate to induce said upward movement.

10. The apparatus of claim 4, each of said actuators comprising a push-rod attached to a lower diffuser plate of said stacked diffuser plates, wherein movement of said push-rod along its length induces a shift of said lower diffuser plate relative to an upper diffuser plate of said stacked diffuser plates along said sliding dimension.

11. The apparatus of claim 10, said push-rod comprising
a nut fixed relative to said upper diffuser plate and
a lead-screw passing through said nut,
wherein rotation of said lead screw induces said movement of said push-rod.
